(19) United States
(12) Patent Application Publication
(10) Pub. No.: US 2020/0216965 A1
(43) Pub. Date: Jul. 9, 2020

(54) METHOD OF SPRAY COATING

(71) Applicant: ROLLS-ROYCE plc, London (GB)

(72) Inventors: Iulian MARINESCU, Singapore (SG); Erjia LIU, Singapore (SG); Ayan BHOWMIK, Singapore (SG); Adrian W. TAN, Singapore (SG); Feng LI, Singapore (SG); Wen SUN, Singapore (SG)

(73) Assignee: ROLLS-ROYCE plc, London (GB)

(21) Appl. No.: 16/720,039

(22) Filed: Dec. 19, 2019

(30) Foreign Application Priority Data
Jan. 7, 2019 (GB) 1900173.4

(51) Int. Cl. C23C 24/04; F02B 77/02; H05B 6/10; H05B 6/14; H05B 6/36

(52) U.S. Cl. CPC C23C 24/04; F02B 77/02; H05B 6/36; H05B 6/14; H05B 6/101

(57) ABSTRACT

A method of spray coating a substrate is disclosed, the method comprising: a step of spray coating metal particles onto a substrate; and a step of induction heating the coating; wherein the step of induction heating comprises performing the induction heating in a vacuum.

### CROSS-REFERENCE TO RELATED APPLICATIONS

This application is based upon and claims the benefit of priority from UK Patent Application Number GB1900173.4 filed on 7th January 2019, the entire contents of which are incorporated herein by reference.

### BACKGROUND

### Technical Field

The present disclosure relates to a method of spray coating a substrate, particularly with a ‘cold spray’ (also known as ‘gas dynamic cold spray’, ‘cold gas dynamic spray’ (CGDS) or ‘kinetic deposition’) spray coating technique.

### Description of the Related Art

Cold gas dynamic spray or simply ‘cold spray’ is an emerging technology for repair or additive manufacturing processes. The basic principle of the cold spray process is that metallic particles are accelerated by high pressure preheated gases (e.g. nitrogen or helium or nitrogen-helium mixture) to supersonic speed (e.g. 500-1000 m/s), and then the particles impact with the substrate and adhere to the surface. Subsequently layers are deposited to build up thick and dense coatings with low oxidation.

The quality of a cold spray coating depends on a velocity ratio η, wherein η=vₚ/v_{crit}, with vₚ being the particle velocity, and v_{crit} the critical velocity for particle deposition. Particles travelling below v_{crit} will tend not to deposit on a substrate, but rather bounce off and/or abrade the substrate surface. Similarly, at very high particle velocities surface erosion can be seen. As such, there is a deposition window that can be defined in terms of the velocity ratio η, in which cold spray techniques need to operate.

The high particle speeds mean that cold spray processes typically operate with much lower particle temperatures, e.g. 500° C. or less, than other thermal spray processes such as plasma spraying, detonation spraying, wire arc spraying, flame spraying, high velocity oxy-fuel spraying (HVOF), or high velocity air fuel spraying (HVAF). This means that the particles are still solid. The term “cold spray” arises due to the relatively low temperatures of the gas exiting the spray nozzle. Initially, the gas is heated to e.g. around 1000° C. in the chamber in order to better increase the gas velocity. However, the gas exiting the convergent-divergent spray nozzle can have a temperature of e.g. around 100-300° C. As a result, compared with other thermal spray processes, both the gas temperature and particle temperature are relatively low for cold spray processes. On account of such low temperature input, the substrates will not suffer from high temperature distortion and thermal stress, and the coating can retain the same solid state as the initial powder used for deposition.

Nickel-based super-alloys are the most commonly used materials for high-temperature components, such as in gas turbine engines, due to their high long-time creep strength and stability at elevated temperatures. These alloys are also good candidate for corrosion resistance in aggressive environments often encountered during service. In particular, Inconel® alloys such as Inconel 718® (hereinafter referred to as IN718) are high-strength and corrosion-resistant nickel-chromium-based materials well suited for service in extreme environments subjected to pressure and heat. Inconel® alloys such as IN718 retain strength over a wide temperature range, attractive for high temperature applications where aluminium and steel would succumb to creep as a result of thermally induced crystal vacancies. Inconel® alloys such as IN 718 can be readily fabricated into complex parts and possesses superb resistance to post-weld cracking. Inconel® alloys such as IN718 find applications throughout industry, including aerospace, oil and gas and power generation just to name a few.

However, cold spraying of Inconel® has proved difficult due to high critical velocities and technical problems, like nozzle clogging. The process can also produce undesirably porous coatings

Furnace heat treatments have been used in cold spraying processes to modify the properties of the coatings formed. For example, U.S. Pat. No. 7,479,299 considers a furnace heat treatment of a cold sprayed coating for aluminium alloys. However, such processes are inefficient, taking a longer lead time to heat treat the material. This is in part because the whole sample is heated, not just the coating, and in part because such furnaces can be slow to change in temperature themselves. In any case, such treatments do little to improve porosity levels. Moreover, furnace treatment inevitably means that the entire component must be so-treated, which may not be desirable for complex components with complex geometries where a local heat treatment method may be preferred.

Other thermal deposition processes like plasma spray, HVOF, present their own problems, including producing residual tensile stresses in the coating, high porosity coatings and low bonding strength of material to the base substrate.

The present invention aims to at least partly address these problems.

### SUMMARY

According to a first aspect there is provided a method of spray coating a substrate, the method comprising: a step of spray coating metal particles onto a substrate; and a step of induction heating the coating; wherein the step of induction heating comprises performing the induction heating in a vacuum.

Optionally, the step of spray coating comprises a step of cold spray coating.

Optionally, the step of cold spray coating comprises spraying the metal particles at a velocity of from 600 m/s to 1000 m/s.

Optionally, the velocity ratio η is 1.3 or greater, preferably 1.4 or greater, wherein η=vₚ/v_{crit}, with vₚ being the particle velocity and v_{crit} the critical velocity for particle deposition.

Optionally, the step of cold spray coating comprises spraying the metal particles with a particle temperature of 750° C. or less.

Optionally, the metal particles are particles of a nickel-based alloy, for example an Inconel alloy such as Inconel 718® or Inconel 625®, or a titanium-based alloy, such as Ti-6Al-4V.

Optionally, the step of induction heating comprises generating an electromagnetic field using an alternating current with a frequency of 100 kHz or more, optionally 120 kHz or more.

Optionally, the step of induction heating comprises applying a current density of 1×10⁵ A/m² or more, optionally 1.22×10⁵ A/m² or more.

Optionally, the step of induction heating comprises heating coating to a target temperature and holding the coating at the target temperature for 5 minutes or more, optionally 10 minutes or more, before allowing the coating to cool.

Optionally, target temperature is 800° C. or more, optionally 850° C. or more and further optionally 900° C. or more.

Optionally, the steps of spray coating and induction heating are repeated to build up a thicker coating.

Optionally, after the step induction heating the coating has a porosity of 1% or less, optionally 0.5% or less and further optionally 0.2% or less.

According to a second aspect of the invention, there is provided a method of repairing a component of a gas turbine engine, the method comprising the method of spray coating a substrate according to the first aspect.

According to a third aspect of the invention, there is provided a method of manufacturing a component for a gas turbine engine, the method comprising additively manufacturing the component by a method of spray coating a substrate according to the first aspect.

According to a fourth aspect of the invention, there is provided a component for a gas turbine engine, wherein the component of the gas turbine engine has been repaired according to the second aspect and/or manufactured according to the third aspect.

According to a fifth aspect of the invention, there is provided an apparatus for spray coating a substrate, the apparatus comprising: a spray coating gun comprising a spray coating nozzle for spray coating metal particles onto a substrate; and an induction coil arranged near or around the spray coating nozzle, wherein the induction coil is configured such that the spray coating gun can spray the metal particles onto the substrate through the induction coil.

According to a fifth aspect of the invention, there is provided a gas turbine engine for an aircraft comprising: an engine core comprising a turbine, a compressor, and a core shaft connecting the turbine to the compressor; a fan located upstream of the engine core, the fan comprising a plurality of fan blades; and a gearbox that receives an input from the core shaft and outputs drive to the fan so as to drive the fan at a lower rotational speed than the core shaft, wherein a component of the gas turbine engine has been repaired according to the second aspect and/or manufactured according to the third aspect.

Optionally, the turbine is a first turbine, the compressor is a first compressor, and the core shaft is a first core shaft; the engine core further comprises a second turbine, a second compressor, and a second core shaft connecting the second turbine to the second compressor; and the second turbine, second compressor, and second core shaft are arranged to rotate at a higher rotational speed than the first core shaft.

As noted elsewhere herein, the present disclosure may relate to a gas turbine engine. Such a gas turbine engine may comprise an engine core comprising a turbine, a combustor, a compressor, and a core shaft connecting the turbine to the compressor. Such a gas turbine engine may comprise a fan (having fan blades) located upstream of the engine core.

Arrangements of the present disclosure may be particularly, although not exclusively, beneficial for fans that are driven via a gearbox. Accordingly, the gas turbine engine may comprise a gearbox that receives an input from the core shaft and outputs drive to the fan so as to drive the fan at a lower rotational speed than the core shaft. The input to the gearbox may be directly from the core shaft, or indirectly from the core shaft, for example via a spur shaft and/or gear. The core shaft may rigidly connect the turbine and the compressor, such that the turbine and compressor rotate at the same speed (with the fan rotating at a lower speed).

The gas turbine engine as described and/or claimed herein may have any suitable general architecture. For example, the gas turbine engine may have any desired number of shafts that connect turbines and compressors, for example one, two or three shafts. Purely by way of example, the turbine connected to the core shaft may be a first turbine, the compressor connected to the core shaft may be a first compressor, and the core shaft may be a first core shaft. The engine core may further comprise a second turbine, a second compressor, and a second core shaft connecting the second turbine to the second compressor. The second turbine, second compressor, and second core shaft may be arranged to rotate at a higher rotational speed than the first core shaft.

In such an arrangement, the second compressor may be positioned axially downstream of the first compressor. The second compressor may be arranged to receive (for example directly receive, for example via a generally annular duct) flow from the first compressor.

The gearbox may be arranged to be driven by the core shaft that is configured to rotate (for example in use) at the lowest rotational speed (for example the first core shaft in the example above). For example, the gearbox may be arranged to be driven only by the core shaft that is configured to rotate (for example in use) at the lowest rotational speed (for example only be the first core shaft, and not the second core shaft, in the example above). Alternatively, the gearbox may be arranged to be driven by any one or more shafts, for example the first and/or second shafts in the example above.

The gearbox may be a reduction gearbox (in that the output to the fan is a lower rotational rate than the input from the core shaft). Any type of gearbox may be used. For example, the gearbox may be a “planetary” or “star” gearbox, as described in more detail elsewhere herein. The gearbox may have any desired reduction ratio (defined as the rotational speed of the input shaft divided by the rotational speed of the output shaft), for example greater than 2.5, for example in the range of from 3 to 4.2, or 3.2 to 3.8, for example on the order of or at least 3, 3.1, 3.2, 3.3, 3.4, 3.5, 3.6, 3.7, 3.8, 3.9, 4, 4.1 or 4.2. The gear ratio may be, for example, between any two of the values in the previous sentence. Purely by way of example, the gearbox may be a “star” gearbox having a ratio in the range of from 3.1 or 3.2 to 3.8. In some arrangements, the gear ratio may be outside these ranges.

In any gas turbine engine as described and/or claimed herein, a combustor may be provided axially downstream of the fan and compressor(s). For example, the combustor may be directly downstream of (for example at the exit of) the second compressor, where a second compressor is provided. By way of further example, the flow at the exit to the combustor may be provided to the inlet of the second turbine, where a second turbine is provided. The combustor may be provided upstream of the turbine(s).

The or each compressor (for example the first compressor and second compressor as described above) may comprise any number of stages, for example multiple stages. Each stage may comprise a row of rotor blades and a row of stator vanes, which may be variable stator vanes (in that their angle of incidence may be variable). The row of rotor blades and the row of stator vanes may be axially offset from each other.

The or each turbine (for example the first turbine and second turbine as described above) may comprise any number of stages, for example multiple stages. Each stage may comprise a row of rotor blades and a row of stator vanes. The row of rotor blades and the row of stator vanes may be axially offset from each other.

Each fan blade may be defined as having a radial span extending from a root (or hub) at a radially inner gas-washed location, or 0% span position, to a tip at a 100% span position. The ratio of the radius of the fan blade at the hub to the radius of the fan blade at the tip may be less than (or on the order of) any of: 0.4, 0.39, 0.38, 0.37, 0.36, 0.35, 0.34, 0.33, 0.32, 0.31, 0.3, 0.29, 0.28, 0.27, 0.26, or 0.25. The ratio of the radius of the fan blade at the hub to the radius of the fan blade at the tip may be in an inclusive range bounded by any two of the values in the previous sentence (i.e. the values may form upper or lower bounds), for example in the range of from 0.28 to 0.32. These ratios may commonly be referred to as the hub-to-tip ratio. The radius at the hub and the radius at the tip may both be measured at the leading edge (or axially forwardmost) part of the blade. The hub-to-tip ratio refers, of course, to the gas-washed portion of the fan blade, i.e. the portion radially outside any platform.

The radius of the fan may be measured between the engine centreline and the tip of a fan blade at its leading edge. The fan diameter (which may simply be twice the radius of the fan) may be greater than (or on the order of) any of: 220 cm, 230 cm, 240 cm, 250 cm (around 100 inches), 260 cm, 270 cm (around 105 inches), 280 cm (around 110 inches), 290 cm (around 115 inches), 300 cm (around 120 inches), 310 cm, 320 cm (around 125 inches), 330 cm (around 130 inches), 340 cm (around 135 inches), 350 cm, 360 cm (around 140 inches), 370 cm (around 145 inches), 380 (around 150 inches) cm, 390 cm (around 155 inches), 400 cm, 410 cm (around 160 inches) or 420 cm (around 165 inches). The fan diameter may be in an inclusive range bounded by any two of the values in the previous sentence (i.e. the values may form upper or lower bounds), for example in the range of from 240 cm to 280 cm or 330 cm to 380 cm.

The rotational speed of the fan may vary in use. Generally, the rotational speed is lower for fans with a higher diameter. Purely by way of non-limitative example, the rotational speed of the fan at cruise conditions may be less than 2500 rpm, for example less than 2300 rpm. Purely by way of further non-limitative example, the rotational speed of the fan at cruise conditions for an engine having a fan diameter in the range of from 220 cm to 300 cm (for example 240 cm to 280 cm or 250 cm to 270 cm) may be in the range of from 1700 rpm to 2500 rpm, for example in the range of from 1800 rpm to 2300 rpm, for example in the range of from 1900 rpm to 2100 rpm. Purely by way of further non-limitative example, the rotational speed of the fan at cruise conditions for an engine having a fan diameter in the range of from 330 cm to 380 cm may be in the range of from 1200 rpm to 2000 rpm, for example in the range of from 1300 rpm to 1800 rpm, for example in the range of from 1400 rpm to 1800 rpm.

In use of the gas turbine engine, the fan (with associated fan blades) rotates about a rotational axis. This rotation results in the tip of the fan blade moving with a velocity Uₜᵢₚ. The work done by the fan blades 13 on the flow results in an enthalpy rise dH of the flow. A fan tip loading may be defined as dH/Uₜᵢₚ², where dH is the enthalpy rise (for example the 1-D average enthalpy rise) across the fan and Uₜᵢₚ is the (translational) velocity of the fan tip, for example at the leading edge of the tip (which may be defined as fan tip radius at leading edge multiplied by angular speed). The fan tip loading at cruise conditions may be greater than (or on the order of) any of: 0.28, 0.29, 0.30, 0.31, 0.32, 0.33, 0.34, 0.35, 0.36, 0.37, 0.38, 0.39 or 0.4 (all values being dimensionless). The fan tip loading may be in an inclusive range bounded by any two of the values in the previous sentence (i.e. the values may form upper or lower bounds), for example in the range of from 0.28 to 0.31, or 0.29 to 0.3.

Gas turbine engines in accordance with the present disclosure may have any desired bypass ratio, where the bypass ratio is defined as the ratio of the mass flow rate of the flow through the bypass duct to the mass flow rate of the flow through the core at cruise conditions. In some arrangements the bypass ratio may be greater than (or on the order of) any of the following: 10, 10.5, 11, 11.5, 12, 12.5, 13, 13.5, 14, 14.5, 15, 15.5, 16, 16.5, 17, 17.5, 18, 18.5, 19, 19.5 or 20. The bypass ratio may be in an inclusive range bounded by any two of the values in the previous sentence (i.e. the values may form upper or lower bounds), for example in the range of form 12 to 16, 13 to 15, or 13 to 14. The bypass duct may be substantially annular. The bypass duct may be radially outside the core engine. The radially outer surface of the bypass duct may be defined by a nacelle and/or a fan case.

The overall pressure ratio of a gas turbine engine as described and/or claimed herein may be defined as the ratio of the stagnation pressure upstream of the fan to the stagnation pressure at the exit of the highest pressure compressor (before entry into the combustor). By way of non-limitative example, the overall pressure ratio of a gas turbine engine as described and/or claimed herein at cruise may be greater than (or on the order of) any of the following: 35, 40, 45, 50, 55, 60, 65, 70, 75. The overall pressure ratio may be in an inclusive range bounded by any two of the values in the previous sentence (i.e. the values may form upper or lower bounds), for example in the range of from 50 to 70.

Specific thrust of an engine may be defined as the net thrust of the engine divided by the total mass flow through the engine. At cruise conditions, the specific thrust of an engine described and/or claimed herein may be less than (or on the order of) any of the following: 110 Nkg⁻¹s, 105 Nkg⁻¹s, 100 Nkg⁻¹s, 95 Nkg⁻¹s, 90 Nkg⁻¹s, 85 Nkg⁻¹s or 80 Nkg⁻¹s. The specific thrust may be in an inclusive range bounded by any two of the values in the previous sentence (i.e. the values may form upper or lower bounds), for example in the range of from 80 Nkg⁻¹s to 100 Nkg⁻¹s, or 85 Nkg⁻¹s to 95 Nkg⁻¹s. Such engines may be particularly efficient in comparison with conventional gas turbine engines.

A gas turbine engine as described and/or claimed herein may have any desired maximum thrust. Purely by way of non-limitative example, a gas turbine as described and/or claimed herein may be capable of producing a maximum thrust of at least (or on the order of) any of the following: 160 kN, 170 kN, 180 kN, 190 kN, 200 kN, 250 kN, 300 kN, 350 kN, 400 kN, 450 kN, 500 kN, or 550 kN. The maximum thrust may be in an inclusive range bounded by any two of the values in the previous sentence (i.e. the values may form upper or lower bounds). Purely by way of example, a gas turbine as described and/or claimed herein may be capable of producing a maximum thrust in the range of from 330 kN to 420 kN, for example 350 kN to 400 kN. The thrust referred to above may be the maximum net thrust at standard atmospheric conditions at sea level plus 15 degrees C. (ambient pressure 101.3 kPa, temperature 30 degrees C.), with the engine static.

In use, the temperature of the flow at the entry to the high pressure turbine may be particularly high. This temperature, which may be referred to as TET, may be measured at the exit to the combustor, for example immediately upstream of the first turbine vane, which itself may be referred to as a nozzle guide vane. At cruise, the TET may be at least (or on the order of) any of the following: 1400K, 1450K, 1500K, 1550K, 1600K or 1650K. The TET at cruise may be in an inclusive range bounded by any two of the values in the previous sentence (i.e. the values may form upper or lower bounds). The maximum TET in use of the engine may be, for example, at least (or on the order of) any of the following: 1700K, 1750K, 1800K, 1850K, 1900K, 1950K or 2000K. The maximum TET may be in an inclusive range bounded by any two of the values in the previous sentence (i.e. the values may form upper or lower bounds), for example in the range of from 1800K to 1950K. The maximum TET may occur, for example, at a high thrust condition, for example at a maximum take-off (MTO) condition.

A fan blade and/or aerofoil portion of a fan blade described and/or claimed herein may be manufactured from any suitable material or combination of materials. For example at least a part of the fan blade and/or aerofoil may be manufactured at least in part from a composite, for example a metal matrix composite and/or an organic matrix composite, such as carbon fibre. By way of further example at least a part of the fan blade and/or aerofoil may be manufactured at least in part from a metal, such as a titanium based metal or an aluminium based material (such as an aluminium-lithium alloy) or a steel based material. The fan blade may comprise at least two regions manufactured using different materials. For example, the fan blade may have a protective leading edge, which may be manufactured using a material that is better able to resist impact (for example from birds, ice or other material) than the rest of the blade. Such a leading edge may, for example, be manufactured using titanium or a titanium-based alloy. Thus, purely by way of example, the fan blade may have a carbon-fibre or aluminium based body (such as an aluminium lithium alloy) with a titanium leading edge.

A fan as described and/or claimed herein may comprise a central portion, from which the fan blades may extend, for example in a radial direction. The fan blades may be attached to the central portion in any desired manner. For example, each fan blade may comprise a fixture which may engage a corresponding slot in the hub (or disc). Purely by way of example, such a fixture may be in the form of a dovetail that may slot into and/or engage a corresponding slot in the hub/disc in order to fix the fan blade to the hub/disc. By way of further example, the fan blades maybe formed integrally with a central portion. Such an arrangement may be referred to as a bladed disc or a bladed ring. Any suitable method may be used to manufacture such a bladed disc or bladed ring. For example, at least a part of the fan blades may be machined from a block and/or at least part of the fan blades may be attached to the hub/disc by welding, such as linear friction welding.

The gas turbine engines described and/or claimed herein may or may not be provided with a variable area nozzle (VAN). Such a variable area nozzle may allow the exit area of the bypass duct to be varied in use. The general principles of the present disclosure may apply to engines with or without a VAN.

The fan of a gas turbine as described and/or claimed herein may have any desired number of fan blades, for example 14, 16, 18, 20, 22, 24 or 26 fan blades.

As used herein, cruise conditions have the conventional meaning and would be readily understood by the skilled person. Thus, for a given gas turbine engine for an aircraft, the skilled person would immediately recognise cruise conditions to mean the operating point of the engine at mid-cruise of a given mission (which may be referred to in the industry as the “economic mission”) of an aircraft to which the gas turbine engine is designed to be attached. In this regard, mid-cruise is the point in an aircraft flight cycle at which 50% of the total fuel that is burned between top of climb and start of descent has been burned (which may be approximated by the midpoint—in terms of time and/or distance—between top of climb and start of descent. Cruise conditions thus define an operating point of, the gas turbine engine that provides a thrust that would ensure steady state operation (i.e. maintaining a constant altitude and constant Mach Number) at mid-cruise of an aircraft to which it is designed to be attached, taking into account the number of engines provided to that aircraft. For example where an engine is designed to be attached to an aircraft that has two engines of the same type, at cruise conditions the engine provides half of the total thrust that would be required for steady state operation of that aircraft at mid-cruise.

In other words, for a given gas turbine engine for an aircraft, cruise conditions are defined as the operating point of the engine that provides a specified thrust (required to provide—in combination with any other engines on the aircraft—steady state operation of the aircraft to which it is designed to be attached at a given mid-cruise Mach Number) at the mid-cruise atmospheric conditions (defined by the International Standard Atmosphere according to ISO 2533 at the mid-cruise altitude). For any given gas turbine engine for an aircraft, the mid-cruise thrust, atmospheric conditions and Mach Number are known, and thus the operating point of the engine at cruise conditions is clearly defined.

Purely by way of example, the forward speed at the cruise condition may be any point in the range of from Mach 0.7 to 0.9, for example 0.75 to 0.85, for example 0.76 to 0.84, for example 0.77 to 0.83, for example 0.78 to 0.82, for example 0.79 to 0.81, for example on the order of Mach 0.8, on the order of Mach 0.85 or in the range of from 0.8 to 0.85. Any single speed within these ranges may be part of the cruise condition. For some aircraft, the cruise conditions may be outside these ranges, for example below Mach 0.7 or above Mach 0.9.

Purely by way of example, the cruise conditions may correspond to standard atmospheric conditions (according to the International Standard Atmosphere, ISA) at an altitude that is in the range of from 10000 m to 15000 m, for example in the range of from 10000 m to 12000 m, for example in the range of from 10400 m to 11600 m (around 38000 ft), for example in the range of from 10500 m to 11500 m, for example in the range of from 10600 m to 11400 m, for example in the range of from 10700 m (around 35000 ft) to 11300 m, for example in the range of from 10800 m to 11200 m, for example in the range of from 10900 m to 11100 m, for example on the order of 11000 m. The cruise conditions may correspond to standard atmospheric conditions at any given altitude in these ranges.

Purely by way of example, the cruise conditions may correspond to an operating point of the engine that provides a known required thrust level (for example a value in the range of from 30 kN to 35 kN) at a forward Mach number of 0.8 and standard atmospheric conditions (according to the International Standard Atmosphere) at an altitude of 38000 ft (11582 m). Purely by way of further example, the cruise conditions may correspond to an operating point of the engine that provides a known required thrust level (for example a value in the range of from 50 kN to 65 kN) at a forward Mach number of 0.85 and standard atmospheric conditions (according to the International Standard Atmosphere) at an altitude of 35000 ft (10668 m).

In use, a gas turbine engine described and/or claimed herein may operate at the cruise conditions defined elsewhere herein. Such cruise conditions may be determined by the cruise conditions (for example the mid-cruise conditions) of an aircraft to which at least one (for example 2 or 4) gas turbine engine may be mounted in order to provide propulsive thrust.

According to an aspect, there is provided an aircraft comprising a gas turbine engine as described and/or claimed herein. The aircraft according to this aspect is the aircraft for which the gas turbine engine has been designed to be attached. Accordingly, the cruise conditions according to this aspect correspond to the mid-cruise of the aircraft, as defined elsewhere herein.

According to an aspect, there is provided a method of operating a gas turbine engine as described and/or claimed herein. The operation may be at the cruise conditions as defined elsewhere herein (for example in terms of the thrust, atmospheric conditions and Mach Number).

According to an aspect, there is provided a method of operating an aircraft comprising a gas turbine engine as described and/or claimed herein. The operation according to this aspect may include (or may be) operation at the mid-cruise of the aircraft, as defined elsewhere herein.

The skilled person will appreciate that except where mutually exclusive, a feature or parameter described in relation to any one of the above aspects may be applied to any other aspect. Furthermore, except where mutually exclusive, any feature or parameter described herein may be applied to any aspect and/or combined with any other feature or parameter described herein.

### DESCRIPTION OF THE DRAWINGS

Embodiments will now be described by way of example only, with reference to the Figures, in which:

FIG. 1 is a sectional side view of a gas turbine engine;

FIG. 2 is a close up sectional side view of an upstream portion of a gas turbine engine;

FIG. 3 is a partially cut-away view of a gearbox for a gas turbine engine;

FIG. 4 is a schematic diagram of a cold spray process;

FIG. 5 is a schematic diagram of an induction heating arrangement;

FIG. 6 is a schematic representation of a combined cold spray and induction heating arrangement;

FIG. 7A is a SEM micrograph of feedstock IN718 powders;

FIG. 7B shows IN718 powder size distribution;

FIG. 8A shows IN718 powder particle velocity distribution measured by a cold spray meter (CSM);

FIG. 8B illustrates the window of deposition for the IN718 particles and the calculated particle velocities, particle temperatures and q values for different particle sizes;

FIGS. 9A-9C present optical micrographs showing microstructures of cold sprayed IN718 coatings;

FIG. 9A shows microstructure of cold sprayed IN718 coating at the state of as-sprayed;

FIG. 9B shows microstructure of cold sprayed IN718 coating at the state of furnace heating at 900° C. for 10 mins;

FIG. 9C shows microstructure of cold sprayed IN718 coating at the state of induction heating at 900° C. for 10 mins;

FIG. 9D represents a schematic illustration of the eddy current flowing through deformed particles;

FIGS. 10A-10D present SEM micrographs showing surface morphology of cold sprayed IN718 coatings;

FIG. 10A shows surface morphology of a cold sprayed IN718 coating at the state of as sprayed;

FIG. 10B shows surface morphology of a cold sprayed IN718 coating at the state of as sprayed;

FIG. 100 shows surface morphology of a cold sprayed IN718 coating at the state of furnace heating at 900° C. for 10 mins;

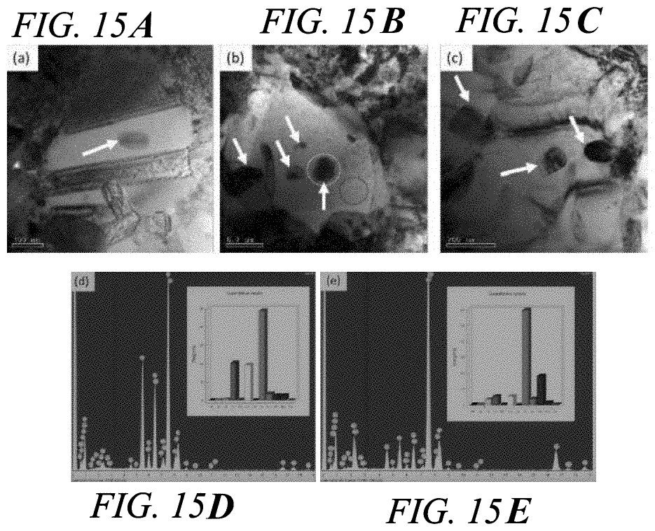

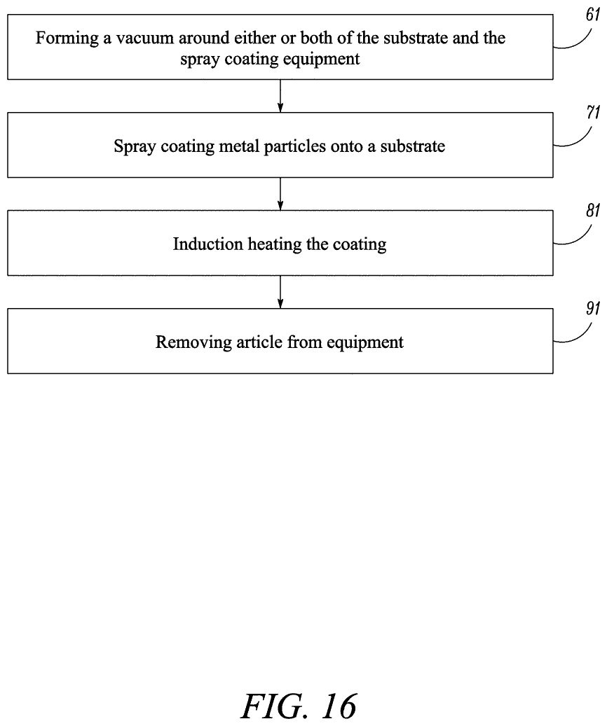

FIG. 10D shows surface morphology of a cold sprayed IN718 coating at the state of furnace heating at 900° C. for 10 mins;

FIG. 10E shows surface morphology of a cold sprayed IN718 coating at the state of induction heating at 900° C. for 10 mins;

FIG. 10F shows surface morphology of a cold sprayed IN718 coating at the state of induction heating at 900° C. for 10 mins;

FIG. 11A is a schematic illustration of a three-point bending test configuration;

FIG. 11B presents load-extension curves of as-sprayed as well as heat treated IN718 coated samples;

FIGS. 12A-12C present SEM micrographs showing fractured morphologies;

FIG. 12A presents a SEM micrograph showing fractured morphologies of an as-sprayed sample;

FIG. 12B presents a SEM micrograph showing fractured morphologies of a furnace heat treated sample for 10 mins;

FIG. 12C presents a SEM micrograph showing fractured morphologies of an induction heat treated for 10 mins sample;

FIGS. 13A-13B present XRD results on IN718 powders and IN718 coatings at the state of as-sprayed, induction heating at 900° C. for 10 mins and furnace heating at 900° C. for 10 mins.;

FIG. 13A presents an X-ray scan revealed a single phase FCC solid solution;

FIG. 13B presents a modified W-H plot for micro strain and crystallite size;

FIG. 14A presents a TEM bright field image of splat microstructure in an as-sprayed film;

FIG. 14B shows selected area electron diffraction (SAD) patterns corresponding to Regions C and D in the preceding images;

FIG. 14C is a TEM bright field image of dislocation recovery within a splat of furnace treated coating, with SAD pattern provided in the inset;

FIGS. 15A-15C present TEM bright field image of fine precipitations (δ-Ni₃Nb) in the grain interiors as indicated by the arrows;

FIG. 15A presents TEM bright field image of fine precipitations (δ-Ni₃Nb) in the grain interiors as indicated by the arrow;

FIG. 15B presents TEM bright field image of fine precipitations (δ-Ni₃Nb) in the grain interiors as indicated by the arrow;

FIG. 15C presents TEM bright field image of fine precipitations (δ-Ni₃Nb) in the grain interiors as indicated by the arrow;

FIG. 15D shows EDS results for grain interiors;

FIG. 15E shows energy-dispersive X-ray spectroscopy (EDS) results of fine precipitations; and

FIG. 16 shows steps to spray coat a substrate.

### DETAILED DESCRIPTION

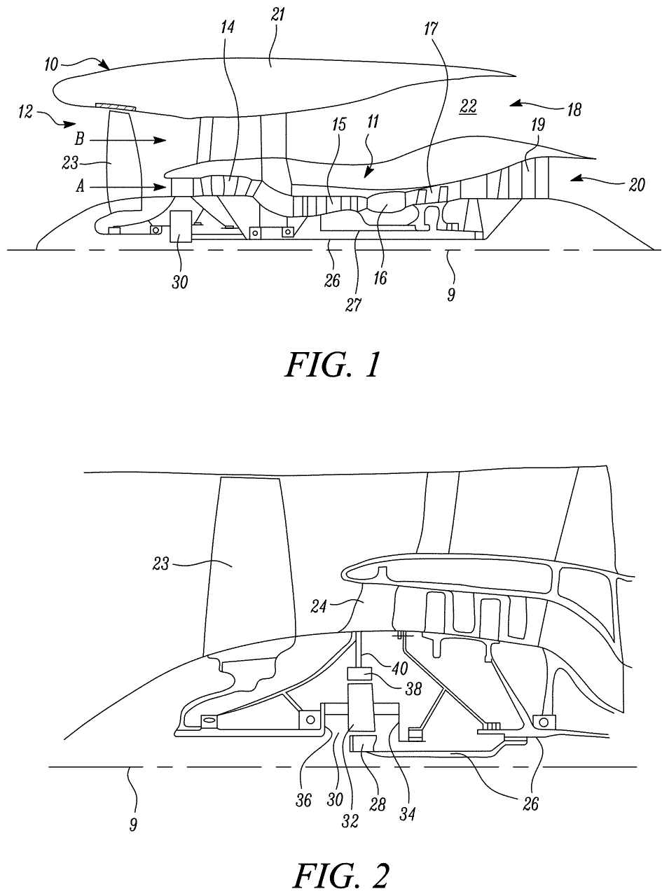

FIG. 1 illustrates a gas turbine engine 10 having a principal rotational axis 9. The engine 10 comprises an air intake 12 and a propulsive fan 23 that generates two airflows: a core airflow A and a bypass airflow B. The gas turbine engine 10 comprises a core 11 that receives the core airflow A. The engine core 11 comprises, in axial flow series, a low pressure compressor 14, a high-pressure compressor 15, combustion equipment 16, a high-pressure turbine 17, a low pressure turbine 19 and a core exhaust nozzle 20. A nacelle 21 surrounds the gas turbine engine 10 and defines a bypass duct 22 and a bypass exhaust nozzle 18. The bypass airflow B flows through the bypass duct 22. The fan 23 is attached to and driven by the low pressure turbine 19 via a shaft 26 and an epicyclic gearbox 30.

In use, the core airflow A is accelerated and compressed by the low pressure compressor 14 and directed into the high pressure compressor 15 where further compression takes place. The compressed air exhausted from the high pressure compressor 15 is directed into the combustion equipment 16 where it is mixed with fuel and the mixture is combusted. The resultant hot combustion products then expand through, and thereby drive, the high pressure and low pressure turbines 17, 19 before being exhausted through the nozzle 20 to provide some propulsive thrust. The high pressure turbine 17 drives the high pressure compressor 15 by a suitable interconnecting shaft 27. The fan 23 generally provides the majority of the propulsive thrust. The epicyclic gearbox 30 is a reduction gearbox.

An exemplary arrangement for a geared fan gas turbine engine 10 is shown in FIG. 2. The low pressure turbine 19 (see FIG. 1) drives the shaft 26, which is coupled to a sun wheel, or sun gear, 28 of the epicyclic gear arrangement 30. Radially outwardly of the sun gear 28 and intermeshing therewith is a plurality of planet gears 32 that are coupled together by a planet carrier 34. The planet carrier 34 constrains the planet gears 32 to precess around the sun gear 28 in synchronicity whilst enabling each planet gear 32 to rotate about its own axis. The planet carrier 34 is coupled via linkages 36 to the fan 23 in order to drive its rotation about the engine axis 9. Radially outwardly of the planet gears 32 and intermeshing therewith is an annulus or ring gear 38 that is coupled, via linkages 40, to a stationary supporting structure 24.

Note that the terms “low pressure turbine” and “low pressure compressor” as used herein may be taken to mean the lowest pressure turbine stages and lowest pressure compressor stages (i.e. not including the fan 23) respectively and/or the turbine and compressor stages that are connected together by the interconnecting shaft 26 with the lowest rotational speed in the engine (i.e. not including the gearbox output shaft that drives the fan 23). In some literature, the “low pressure turbine” and “low pressure compressor” referred to herein may alternatively be known as the “intermediate pressure turbine” and “intermediate pressure compressor”. Where such alternative nomenclature is used, the fan 23 may be referred to as a first, or lowest pressure, compression stage.

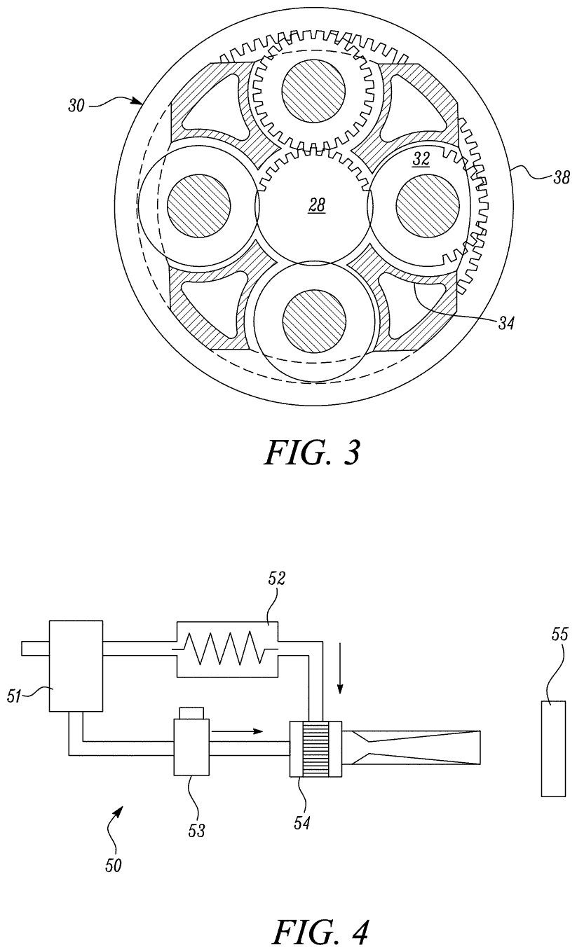

The epicyclic gearbox 30 is shown by way of example in greater detail in FIG. 3. Each of the sun gear 28, planet gears 32 and ring gear 38 comprise teeth about their periphery to intermesh with the other gears. However, for clarity only exemplary portions of the teeth are illustrated in FIG. 3. There are four planet gears 32 illustrated, although it will be apparent to the skilled reader that more or fewer planet gears 32 may be provided within the scope of the claimed invention. Practical applications of a planetary epicyclic gearbox 30 generally comprise at least three planet gears 32.

The epicyclic gearbox 30 illustrated by way of example in FIGS. 2 and 3 is of the planetary type, in that the planet carrier 34 is coupled to an output shaft via linkages 36, with the ring gear 38 fixed. However, any other suitable type of epicyclic gearbox 30 may be used. By way of further example, the epicyclic gearbox 30 may be a star arrangement, in which the planet carrier 34 is held fixed, with the ring (or annulus) gear 38 allowed to rotate. In such an arrangement the fan 23 is driven by the ring gear 38. By way of further alternative example, the gearbox 30 may be a differential gearbox in which the ring gear 38 and the planet carrier 34 are both allowed to rotate.

It will be appreciated that the arrangement shown in FIGS. 2 and 3 is by way of example only, and various alternatives are within the scope of the present disclosure. Purely by way of example, any suitable arrangement may be used for locating the gearbox 30 in the engine 10 and/or for connecting the gearbox 30 to the engine 10. By way of further example, the connections (such as the linkages 36, 40 in the FIG. 2 example) between the gearbox 30 and other parts of the engine 10 (such as the input shaft 26, the output shaft and the fixed structure 24) may have any desired degree of stiffness or flexibility. By way of further example, any suitable arrangement of the bearings between rotating and stationary parts of the engine (for example between the input and output shafts from the gearbox and the fixed structures, such as the gearbox casing) may be used, and the disclosure is not limited to the exemplary arrangement of FIG. 2. For example, where the gearbox 30 has a star arrangement (described above), the skilled person would readily understand that the arrangement of output and support linkages and bearing locations would typically be different to that shown by way of example in FIG. 2.

Accordingly, the present disclosure extends to a gas turbine engine having any arrangement of gearbox styles (for example star or planetary), support structures, input and output shaft arrangement, and bearing locations.

Optionally, the gearbox may drive additional and/or alternative components (e.g. the intermediate pressure compressor and/or a booster compressor).

Other gas turbine engines to which the present disclosure may be applied may have alternative configurations. For example, such engines may have an alternative number of compressors and/or turbines and/or an alternative number of interconnecting shafts. By way of further example, the gas turbine engine shown in FIG. 1 has a split flow nozzle 18, 20 meaning that the flow through the bypass duct 22 has its own nozzle 18 that is separate to and radially outside the core engine nozzle 20. However, this is not limiting, and any aspect of the present disclosure may also apply to engines in which the flow through the bypass duct 22 and the flow through the core 11 are mixed, or combined, before (or upstream of) a single nozzle, which may be referred to as a mixed flow nozzle. One or both nozzles (whether mixed or split flow) may have a fixed or variable area. Whilst the described example relates to a turbofan engine, the disclosure may apply, for example, to any type of gas turbine engine, such as an open rotor (in which the fan stage is not surrounded by a nacelle) or turboprop engine, for example. In some arrangements, the gas turbine engine 10 may not comprise a gearbox 30.

The geometry of the gas turbine engine 10, and components thereof, is defined by a conventional axis system, comprising an axial direction (which is aligned with the rotational axis 9), a radial direction (in the bottom-to-top direction in FIG. 1), and a circumferential direction (perpendicular to the page in the FIG. 1 view). The axial, radial and circumferential directions are mutually perpendicular.

The inventors have identified that components, such as the components of the gas turbine engine 10 can be manufactured or repaired using a technique that produces improved properties, in particular improved porosities, compared to conventional approaches. In particular, a deposited coating can be heated by induction heating following its deposition. This results in an improved bond with the substrate, and a lower porosity of coating.

FIG. 4 is a schematic diagram of a cold spray system 50. Although the discussion below is illustrated with respect to a cold spray technique, it is applicable to other forms of particle spray deposition too. Such techniques include plasma spray coating, high velocity oxygen fuel (HVOF) coating, high velocity air fuel (HVAF) coating and thermal spray coating.

In summary, a gas, such as N₂ or He is supplied to a gas control module 51. The gas control module 51 sends some gas to a heater 52 and some to a powder feeder 53.

The gas sent to the powder feeder 53 entrains powder particles that are to be used for the coating. The particles may be particles of a nickel-based alloy, for example Inconel 718® or Inconel 625®, or a titanium-based alloy, such as Ti-6Al-4V.

The stream of entrained powder particles from the powder feeder 53 is combined with the heated gas from the heater 52 at or before a supersonic nozzle 54, which accelerates the particle stream to the desired velocity. Such velocities could be in the range of 600 m/s to 1000 m/s. The velocity ratio, η=vₚ/v_{crit}, (wherein vₚ is the particle velocity, and v_{crit} is the critical velocity for particle deposition) can be 1.3 or greater, preferably 1.4 or greater.

The particles are ejected from the nozzle 54 to impinge upon a substrate 55, to form a deposit on the surface of the substrate 55. The impinging particles may have a temperature of 750° C. or less in a cold spray arrangement. The substrate 55 can be of the same material as the particles.

The nozzle 54 or the substrate 55 may be moved during deposition to change the area of deposition on the substrate 55 surface.

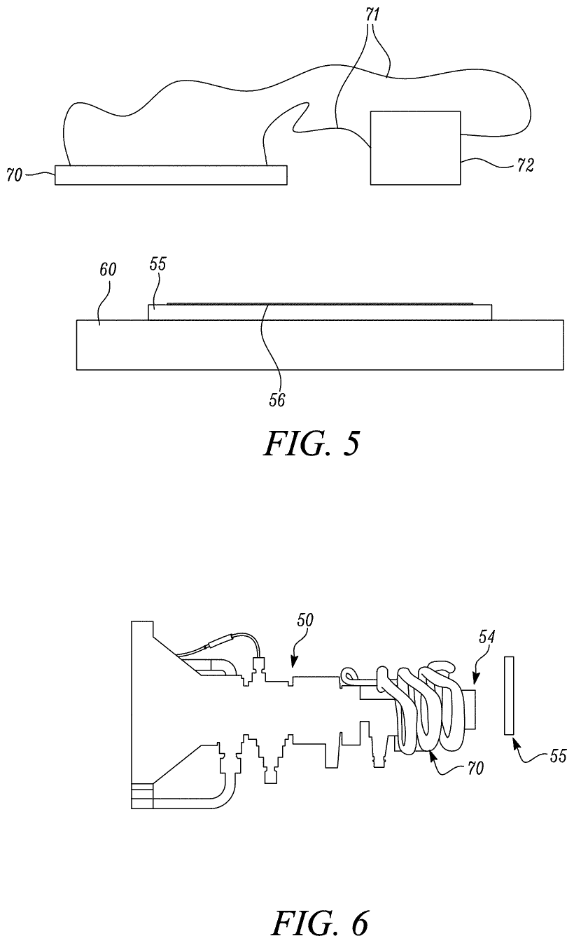

FIG. 5 is a schematic diagram showing how a deposited layer or coating 56 on a substrate 55 can be heated by induction. The coated substrate 55 can be positioned on a support 60, under an induction coil 70 (which may be a copper coil, for example). The coil 70 is supplied with alternating current from a power source 72 via wires 71. The alternating current may have a frequency of 100 kHz or more, optionally 120 kHz or more. The coil 70 may applying a current density of 1×10⁵ A/m² or more, optionally 1.22×10⁵ A/m² or more to the coating 56.

The alternating electromagnetic field generated by the coil 70 causes inductive heating in the coating 56. The step of induction heating can comprise heating the coating to a target temperature, and holding the coating at the target temperature. The target temperature may be 800° C. or more, optionally 850° C. or more and further optionally 900° C. or more.

The coating may be held at the target temperature, for example, for 5 minutes or more, optionally 10 minutes or more, before allowing the coated substrate to cool.

Heating the coating to the target temperature may be performed in vacuum. Heating to the target temperature may take, for example, 3 minutes, with the sample being held at temperature for 10 minutes before cooling for 4 minutes. As such, the heat treatment cycle is fast—e.g. 17 minutes in this example. The cooling may be performed under an inert atmosphere, e.g. Argon.

FIG. 6 illustrates how an induction heating arrangement may be integrated with a cold spray process. The induction coil 70 may be provided around or near to the cold spray nozzle 54. As such, the coating 56 may be heated as it is applied to the substrate 55. That is, the particles may be sprayed through the induction coil 70.

By using induction heat treatment (IHT) in this way, it is surprisingly found that improved structural properties are achieved compared to e.g. furnace heat treatment (FHT). In particular coatings adhere better to the substrate and exhibit reduced porosities. Coatings with 1% or less porosity can be achieved, even 0.5% or less and even 0.2% or less.

The invention is discussed further below with reference to examples.

### Experimental Methods

### Materials

Commercial IN718 powders (25-45 μm) were used for deposition. The particle size distribution was measured by a laser assisted equipment. Annealed cold rolling IN718 substrates (50 mm×50 mm×3.2 mm in size) were used.

### Cold Spray Process

A high pressure cold spray system (Impact Spray System 5/11) was used for the deposition. N₂ was used as propelling gas at 1000° C. and 4.5 MPa. The standoff distance between the nozzle exit and the substrate surface was 30 mm and the spray gun was vertical to the substrate surface. The nozzle scanning speed was fixed at 500 mm/s. The feed rate of IN718 powder was around 46 g/min. For these parameters used, the average particle velocity was around 713 m/s, as measured right before they impacted the substrate surface by using a cold spray velocimeter. The number of deposition passes was 10.

The spraying parameters (temperature and pressure) were selected by using the commercial software package KSS from Kinetic Spray Solutions (Buchholz, Germany). The calculated particle velocities were cross checked by velocity measurements using the cold spray velocimeter. Cold spraying of IN718 was performed at a process gas pressure of 45 bar and process gas temperatures of 1000° C., corresponding to average η value of 1.41.

### Heat Treatment Process

The as-sprayed IN718 samples were put underneath a copper coil into a bell jar heating system with high vacuum environment. Alternating current (AC) was passed a copper coil to produce a changing magnetic field in and around the coil, therefore, the eddy current will be induced in the IN718 coated samples. The frequency of the current was 120 kHz and the current densities were 1.22×10⁵ A/m². Surface temperature of the IN718 samples was 900±10° C., as measured by laser thermometer and calibrated by thermal couples, which were held for 10 mins and cooled down with argon protection. For comparison, traditional furnace heat treatment methods were carried out at the 900±15° C. for 10 mins. Temperature within the furnace was calibrated by using calibration thermocouple with omega temperature calibrator. After heat treatment process, the centre parts were cut from the samples for analysis.

### Microstructure Characterization

Optical microscopy was used to analyse the cross-sectional microstructures of the IN718 coatings. ImageJ software (available from https://imagej.nih.gov/ij/index.html) was used to calculate the coating porosity levels. Scanning electron microscopy was used to analyse the surface morphology and fracture surface. Transmission electron microscopy was used to analyse the coating microstructures in high magnification. In order to investigate the coating flexural strength, MTS 810 Material Testing System was used to carry out the three-point bending test. The samples used for bending test were 50 mm×10 mm×4.2 mm and the loading rate was 0.5 mm/s until failure occurred. Three samples were repeated for each condition. Fracture surfaces were analysed by SEM.

### Experimental Results and Discussion

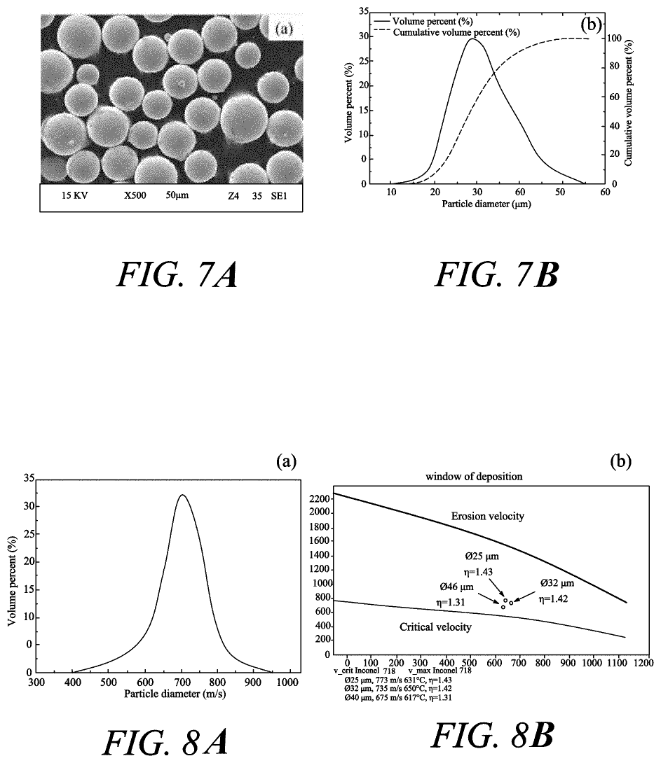

FIG. 7(a) is a micrograph of the IN718 powder as received. The IN718 particles are near spherical shape with the particle size falling in the narrow range from 20 to 45 μm. As can be seen from the SEM image, the surfaces of the particles are smooth without satellite particles attached, providing superior flowability of the particles during the cold spray process. The particle size distribution is displayed in FIG. 7(b), which shows that the IN718 particles fall within a narrow range and the average particle size is around 32 μm.

The particle velocity distribution is shown in FIG. 8(a), which was measured by cold spray velocimeter. Most of the particle velocities fall within the range from 600 to 800 m/s. The critical velocity and deposition window in this study was calculated by using the KSS software (Kinetic Spraying Solutions, Germany) and the results are presented in FIG. 8(b). Particle temperature and η values are shown to fall within the window of deposition which implies that high deposition efficiency is expected to be achieved. The particle temperatures for 25 μm, 32 μm and 46 μm particles are 640° C., 657° C. and 616° C., respectively.

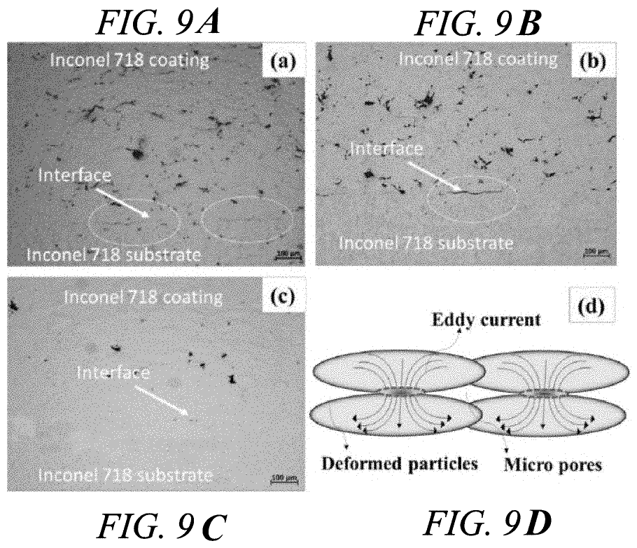

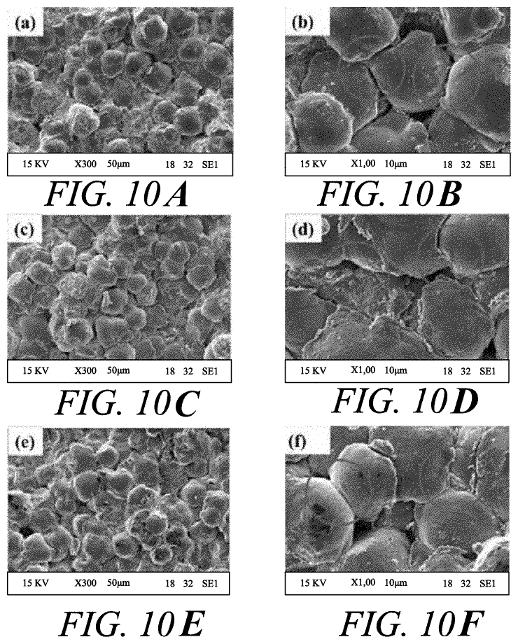

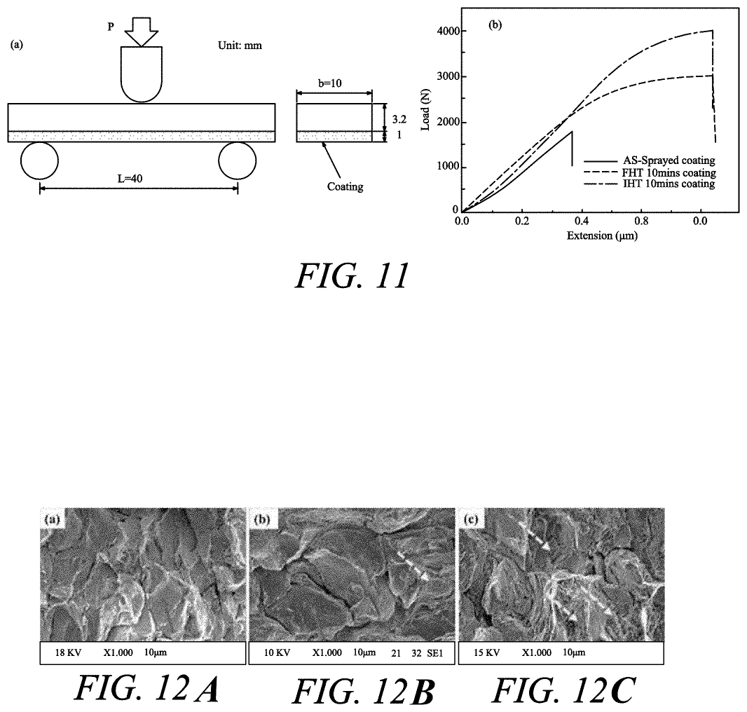

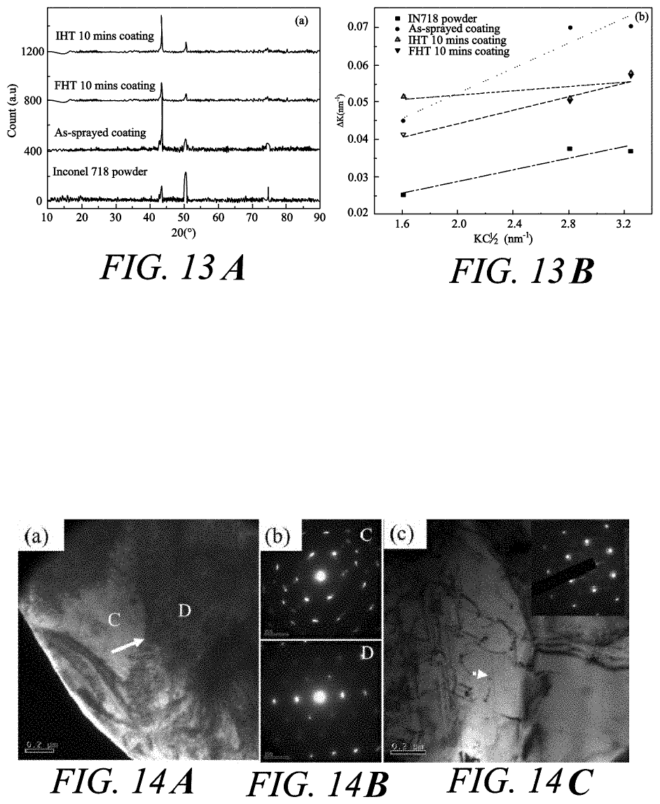

The microstructure of a representative cross-section of the as-sprayed coating is shown in FIG. 9(a). The coating porosity level was analysed by using image analysis of the pore volume fraction. With these conditions, the porosity level of the IN718 coatings was 1.7%. In as-sprayed sample, the irregular pores were relatively homogeneously distributed across the coating and the microcracks within the coating indicated poor bonding between particles. After furnace heat treatment at 900° C. at 10 mins, the irregular micro pores changed into rounded pores and microcracks became less as shown in FIG. 9(b), although the coating porosity did not change obviously, which reduced from 1.7% to 1.6%. However, after induction heat treatment, the porosity reduced significantly and the microcracks were invisible. Significant consolidation occurred during the induction heating process, as shown in FIG. 9(c). It is noticeable the coating porosity level decreased from 1.7% to 0.2% after 10 mins of being held at 900° C. in the induction heat treatment system.

Without wishing to be bound by theory, it is hypothesised that although the surface temperature was the same for the two heating methods, the differing microstructures could be due to the induction heat treatment induce higher current density at the particle necks, causing enhanced material flux and diffusion between the particles, thus resulting in lower coating porosity. FIG. 9(d) illustrates this, showing a schematic illustration of the eddy current flowing through deformed particles, the current is forced through the narrow contact areas between deformed powder particles, thus resulting in higher current densities and higher local temperatures at the narrow contact areas.

The effect of a field on mass transport can be evaluated from the electromigration theory:

$${J}_{i} = - \frac{{D}_{i} {C}_{i}}{RT} [ \frac{RT \partial ln {C}_{i}}{\partial x} + {Fz}^{*} E ]$$

where Jᵢ is the flux of the diffusing ith species, Dᵢ is the diffusivity of the species, Cᵢ is the concentration of the species, F is Faraday's constant, z* is the effective charge on the diffusing species, E is the current field, R is the gas constant, and T is temperature.

As can be seen from the above equation, current field can contribute to mass transport and the flux of the diffusing the particle.

By comparing the interfaces between substrates and coatings in FIG. 9, after induction heat treatment, the coating/substrate interface was more intimate and even cannot distinguish the interface line, which revealed that adhesion strength was significantly improved. It is considered that the reason for this is likely the same as effect as explained above—i.e. eddy current field promoting atomic diffusion between coating and substrate at points of contact.

The surface morphology of IN718 as-sprayed and heat-treated coatings were also observed by SEM in low and high magnifications, which are shown in FIG. 10. The images show (a high and low magnifications respectively) the particles (a & b) as-sprayed, (c & d) after furnace heating at 900° C. for 10 mins and (e & f) after induction heating at 900° C. for 10 mins.

In FIG. 10(b & d), the unbonded interparticle regions are obvious. However, FIG. 10(f) shows that the interparticle regions are strongly bonded without spacing between. These results again imply that the induction heat treatment may cause fast electromigration-assisted material flux, thus, enhancing the diffusion of interparticle regions, in agreement with the cross-section microstructure observations above. Such diffusion of interparticle regions will decrease the coating porosity as well as increase the cohesive strength.

FIG. 11(a) schematically illustrates a three-point bending test configuration. FIG. 11(b) shows the load-extension curves measured from three-point bending tests for the as-sprayed and furnace (FHT) and induction (IHT) heat treated IN718 coated samples. As mentioned above, the substrate thickness was 3.2 mm, and an approximately 1 mm coating was applied. A section of the coated substrate 10 mm wide was tested. A load was applied to the coated substrate midway between two supporting points, spaced 40 mm apart.

As shown in FIG. 11(b), the as-sprayed IN718 sample could survive under 1770 N load. However, furnace heat treated samples could survive under 3042 N. Induction heat treated samples could survive under still higher, around 4000 N, before the coating cracked. As such, it is clear that the particle-particle bonding strength was significantly improved after heat treatment, which was probably due to the strain released as well as diffusion between particles improved. FIG. 11(b) also shows that the as-sprayed coating failed abruptly, which indicates the as-sprayed coating to be brittle, fracturing without elongation. However, ductility of the coatings increased significantly after induction heat treatment.

FIG. 12 shows the coating fracture surface morphologies after three-point bending tests. For as-sprayed coating FIG. 12(a), the fracture occurred between the interfaces of particles and the fracture surface was smooth (as indicated by the solid arrow) and very limited dimples were observed, which represents the brittle nature of as-sprayed coating. It seems that de-cohesive rupture occurred to the as-sprayed IN718 coating since its cohesion of particles is relatively weak without heat treatment.

After furnace heat treatment, the fracture surface was less smooth with limited dimples (dash arrow), which implied the improvement of coating cohesive strength and ductility. However, the coating still fractured at particle interface after heat treatment at 900° C. for 10 mins, even with some diffusion between the particle interfaces as shown in FIG. 12(b). This failure can still be considered as a de-cohesive rupture. However, some defects and microcracks still can be observed at the fracture surface, which suggests heat treatment cannot fix all of the defects or pores inside the coating.

After induction heat-treated at 900° C., plenty of dimples were observed at the fracture surface and the dimples at the fracture surface look uniform, as shown in FIG. 12(c) (dash arrows). Compared to the as-sprayed IN718 coating, it can be seen that particle interface becomes less visible after induction heat treatment due to diffusion. The fracture bypassed through the deformed and diffused particles and consequently, made the fracture surface rougher, which indicated a favourable characteristic of great improvement of cohesive strength as well as coating ductility.

XRD profiles were obtained from IN718 powder as received and IN718 coatings at different states (as-sprayed, after furnace heating for 10 mins, after induction heating for 10 mins), as shown in FIG. 13(a). In each profile, the three peaks are the diffracting planes, namely (111), (200) and (220). Analysis of the peak positions and inter-planer spacing ratios for the peaks confirms a single-phase F.C.C solid solution structure for the powders and coatings. Compared to the IN718 powder peaks, the coating peaks show a significantly peak broadening indicating the presence of relatively higher micro strain in the coating structure. After heat treatment, the peaks became shaper, due to residual stress relaxation within the coatings.

A modified Williamson-Hall method was used to extract the average crystallite size and amount of micro strain, the results of which are shown in FIG. 13(b).

The modified Williamson-Hall equation is written in the form of

$$Δ K = \frac{0.9}{{D}_{s}} + ɛ {KC}^{\frac{1}{2}}$$

where, Dₛ is the average crystallite size, ε is the average micro-strain,

$$K = \frac{2 sin θ}{λ} and$$

$$Δ K = \frac{( 2 Δθ ) sin θ}{λ} ,$$

θ is Bragg's angle of diffraction, Δθ is half of Full Width Half Maxima (FWHW) of the diffraction peak, λ is the X-Ray wavelength and C is the average contrast factor for a particular diffraction peak. The intercept and slope of the plot determine the crystallite size and presence of micro strain in the material, which are shown in Table 1.

On the other hand, micro strain e is mainly induced by dislocations, from which dislocation density can be calculated by following formula

$$ɛ = {( {BM}^{2} )}^{\frac{1}{2}} {ρ}^{\frac{1}{2}} ,$$

where

$$B = \frac{π {b}^{2}}{2}$$

is Burgers vector (for IN718: 0.25 nm), M is a constant (i.e. 1.5) which is related to effective dislocation cut-off radius Rₑ and dislocation densities, and ρ is dislocation density.

The calculated dislocation densities for powder and cold sprayed coatings are shown in Table 1.

TABLE 1
Table showing crystallite size and micro strain of IN718
power and coatings as calculated from W-H plot.

| | Crystallite size | | Dislocation density |
|---|---|---|---|
| IN718 | (nm) | Micro-strain | (m⁻²) |
| As-sprayed coating | ~46 | 1.7 × 10⁻² | 1.3 × 10¹⁵ |
| Induction Heat | ~157 | 3 × 10⁻³ | 4.1 × 10¹³ |
| Treatment (IHT) 10 | | | |
| mins coating | | | |
| Furnace Heat | ~113 | 9 × 10⁻³ | 3.7 × 10¹⁴ |
| Treatment (FHT) 10 | | | |
| mins coating | | | |

The significant slope of the modified Williamson-Hall plot indicates that the coatings contain a large amount of micro strain as a result of extensive plastic deformation. This micro strain is related to the presence of defects, particularly dislocations which are created during the cold spray deposition process. As can be seen from Table 1, the dislocation densities for powder and as-sprayed coatings were 2.9×10¹⁴ m⁻² and 1.3×10¹⁵ m⁻², respectively. The average crystallite size of the cold sprayed coatings was found to be approximately 46 nm, which is smaller than that in the as received powder, i.e. ˜67 nm. The reduced sub-grain or crystallite size in coating is considered to be a consequence of the severe plastic deformation that occurs in the powder particle upon impact on the substrate surface during the cold spray process. Presence of smaller crystallites and a sizable micro-strain indicate the formation of sub-grains in the severely deformed microstructure of the individual ‘splat’ in the coating. After furnace heat treatment, the crystallite size increased to ˜113 nm and the micro strain decreased in the coatings. The dislocation densities reduced from 1.3×10¹⁵ m⁻² to 3.7×10¹⁴ m⁻² which is indicative of initiation of recovery processes in the microstructure. As a direct consequence of this, the crystallite size is also observed to increase to ˜113 nm. However, after induction heat treatment, the dislocation densities in the coating further reduced to 4.1×10¹³ m⁻², with the least micro-strain. Therefore, by comparison to furnace heat treatment (FHT), it seems that eddy current fields in the induction heat treatment (IHT) promote a high degree of relaxation of the micro-strain possibly through recovery mechanisms such as dislocation annihilation and polygonization also subsequent growth of the crystallite. The crystallite size obtained from the W-H plot is in agreement with the dislocation cell size (defect free regions bounded by dislocation walls) obtained from the analysis of the TEM images of the as-deposited coatings as discussed later. The decreased micro-strains contribute to the coating ductility that are in good agreement with the results as shown in three-point bending test.

For completeness, it is noted that for severely deformed material the calculated crystallite size from XRD using W-H method is usually lower than the sub-grain size observed from TEM analysis. The crystallite size measured from XRD is equivalent to the average size of domains which scatter X-rays coherently. X-ray diffraction can resolve the difference between dislocation cells or sub-grains even if the misorientations are very small (which is even unresolvable by TEM).

The TEM bright field image provided in FIG. 14(a) shows the representative microstructure of a splat within an as-sprayed coating. Dark contrast regions in the microstructure represent deformation-induced defects, particularly dislocations. Bright regions are relatively defect-free grains.

FIG. 14(a) shows a very high density of dislocations which indicate an intense plastic deformation of the as-sprayed coating. The dislocations formed from the impact during the cold spray interact with each other leading to their self-organization into dislocation boundaries and walls. The accumulation of dislocations at a wall triggers net rotation of portions of matter with respect to its surrounding. Such rotations when become large enough to cause the dislocation boundary to eventually evolve into a grain boundary. SAD patterns obtained from the regions C and D are provided in FIG. 14(b) C and D. This is a direct proof of recrystallization. It is also interesting that the diffraction spots are distorted and elongated, which again indicates that high deformation-induced strains within as-sprayed coating.

FIG. 14(c) shows the TEM images at the IN718 coating after furnace heat treatment. Comparing with the as-sprayed sample microstructure in FIGS. 14(a) and (b), the FHT sample is characterized by the presence of large grains and larger spacing twins by a significant reduction in dislocation density, indicating some recovery has occurred in the microstructure during the HT process. As can be seen from this result, the grain was recrystallized and grew into sub-micro order, caused by heat treatment. Thus heat treatability of this coating would be a highly desirable trait.

FIGS. 15(a to c) show the TEM images at the IN718 coating after induction heat treatment. In this condition, the microstructure is characterized by the presence of larger grain structures and also by a significant reduction in dislocation density, indicating that significant recovery has occurred in the microstructure during the induction process. This is considered to be due to eddy current promoting atomic motion and results in more significant reduction in dislocation density. Very fine distribution of precipitates (δ-Ni₃Nb) in some grain interiors were found. In general, precipitation tended to be localized at pre-existing grain boundaries. However, under induction heat treatment conditions, fine precipitations (δ-Ni₃Nb) were distributed in the grain interiors, shown by the arrows in these micrographs. Energy-dispersive X-ray spectroscopy (EDS) result of precipitation are shown in FIG. 16(e), showing higher Nb element contents than surroundings. The fine distributed precipitations could be attributed to the electric field, which has the following two effects: the activation energy formation of new phases changes in an electric field and diffusion rate increases significantly in electric field. The free energy forming critical nuclei size in the electric field is given as:

$$Δ {G}_{c} = \frac{16 π {σ}^{3}}{{3 [ \vert Δ {G}_{V} \vert + \frac{1}{2} {E}^{2} ( {ɛ}_{1} - {ɛ}_{2} ) ]}^{2}}$$

where σ is interfacial energy, ΔGᵥ is driving free energy, E is electric field, ε₁ and ε₂ are the dielectric constants of the matrix and precipitating phase, respectively.

Electric field can promote the precipitating by reducing the free energy needed to form critical nuclei. Thus, some incompletely recovered interior dislocations could act as inhomogeneous nucleation sites for precipitation and quite a number of precipitations were formed. Compared with furnace heat treatment, the precipitate size in induction heat treatment coating is much smaller. The fine distribution of precipitates in some grain interiors can inhibit dislocation motion and could also contribute to pinning dislocation motion, which would significantly improve the coating strength. Moreover, the overall precipitate density in the heat treated cold sprayed material is low compared to that typically reported for IN718. This observation likely indicates a variation in precipitation behaviour caused by the presence of a heavily deformed microstructure in the as-deposited coating.

FIG. 16 shows steps to spray coat a substrate, comprising:
Forming a vacuum around either or both of the substrate and the spray coating equipment 61;
Spraying coat metal particles onto a substrate 71;
Induction heating the coating 81; and,
Removing the article from the equipment 91.

It will be understood that the invention is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

1. A method of spray coating a substrate, the method comprising:
a step of spray coating metal particles onto a substrate; and
a step of induction heating the coating;
wherein the step of induction heating comprises performing the induction heating in a vacuum.

2. The method of spray coating as claimed in claim 1, wherein the step of spray coating comprises a step of cold spray coating.

3. The method of spray coating as claimed in claim 2, wherein the step of cold spray coating comprises spraying the metal particles at a velocity of from 600 m/s to 1000 m/s.

4. The method of spray coating as claimed in claim 2, wherein the velocity ratio η is 1.3 or greater, preferably 1.4 or greater, wherein η=vₚ/v_{crit}, with vₚ being the particle velocity and v_{crit} the critical velocity for particle deposition.

5. The method of spray coating as claimed in claim 2, wherein the step of cold spray coating comprises spraying the metal particles with a particle temperature of 750° C. or less.

6. The method of spray coating as claimed in claim 1, wherein the metal particles are particles of a nickel-based alloy, or a titanium-based alloy, such as Ti-6Al-4V.

7. The method of spray coating as claimed in claim 1, wherein the step of induction heating comprises generating an electromagnetic field using an alternating current with a frequency of 100 kHz or more, optionally 120 kHz or more.

8. The method of spray coating as claimed in claim 1, wherein the step of induction heating comprises applying a current density of 1×10⁵ A/m² or more, optionally 1.22×10⁵ A/m² or more.

9. The method of spray coating as claimed in claim 1, wherein the step of induction heating comprises heating coating to a target temperature, and holding the coating at the target temperature for 5 minutes or more, optionally 10 minutes or more, before allowing the coating to cool.

10. The method of spray coating as claimed in claim 9, wherein target temperature is 800° C. or more, optionally 850° C. or more and further optionally 900° C. or more.

11. The method of spray coating as claimed in claim 1, wherein the steps of spray coating and induction heating are repeated to build up a thicker coating.

12. The method of spray coating as claimed in claim 1, wherein after the step induction heating the coating has a porosity of 1% or less, optionally 0.5% or less and further optionally 0.2% or less

13. A method of repairing a component of a gas turbine engine, the method comprising the method of spray coating a substrate as claimed in claim 1, wherein the component of the gas turbine engine is the substrate.

14. A method of manufacturing a component for a gas turbine engine, the method comprising additively manufacturing the component by a method of spray coating a substrate as claimed in claim 1.

15. A component for a gas turbine engine, wherein the component of the gas turbine engine has been repaired as claimed in claim 13.

16. A component for a gas turbine engine, wherein the component of the gas turbine engine has been manufactured as claimed in claim 14.

17. An apparatus for spray coating a substrate, the apparatus comprising:
a spray coating gun comprising a spray coating nozzle for spray coating metal particles onto a substrate; and
an induction coil arranged near or around the spray coating nozzle, wherein the induction coil is configured such that the spray coating gun can spray the metal particles onto the substrate through the induction coil.

18. A gas turbine engine for an aircraft comprising:
an engine core comprising a turbine, a compressor, and a core shaft connecting the turbine to the compressor;
a fan located upstream of the engine core, the fan comprising a plurality of fan blades; and
a gearbox that receives an input from the core shaft and outputs drive to the fan so as to drive the fan at a lower rotational speed than the core shaft,
wherein a component of the gas turbine engine has been manufactured as claimed in claim 14.

19. A gas turbine engine for an aircraft comprising:
an engine core comprising a turbine, a compressor, and a core shaft connecting the turbine to the compressor;
a fan located upstream of the engine core, the fan comprising a plurality of fan blades; and
a gearbox that receives an input from the core shaft and outputs drive to the fan so as to drive the fan at a lower rotational speed than the core shaft,
wherein a component of the gas turbine engine has been repaired as claimed in claim 13.

20. The gas turbine engine as claimed in claim 19, wherein:
the turbine is a first turbine, the compressor is a first compressor, and the core shaft is a first core shaft;
the engine core further comprises a second turbine, a second compressor, and a second core shaft connecting the second turbine to the second compressor; and
the second turbine, second compressor, and second core shaft are arranged to rotate at a higher rotational speed than the first core shaft.
